(19) United States
(12) Patent Application Publication
(10) Pub. No.: US 2017/0039470 A1
(43) Pub. Date: Feb. 9, 2017

(54) FACTOR EXTRACTION SYSTEM AND FACTOR EXTRACTION METHOD

(71) Applicant: HITACHI, LTD., Tokyo (JP)

(72) Inventors: Junichi HIRAYAMA, Tokyo (JP); Ryuji MINE, Tokyo (JP)

(73) Assignee: Hitachi, Ltd., Tokyo (JP)

(21) Appl. No.: 15/102,303

(22) PCT Filed: Dec. 25, 2013
(86) PCT No.: PCT/JP2013/084625

§ 371 Date: Jun. 7, 2016

(51) Int. Cl. G06N 3/08; G06N 3/04

(52) U.S. Cl. CPC G06N 3/08; G06N 3/0436

(57) ABSTRACT

An objective of the present invention is to efficiently identify a combination of other variables which contribute to variation of a target variable, and extract same as explanatory variables (factors). A factor extraction system according to the present invention defines a covariant composite variable which is configured of a combination of event variables and a binary number which represents whether the combination is present in event data, and obtains a correlation between the covariant composite variable and the target variable, thereby extracting contribution factors.

### TECHNICAL FIELD

The present invention relates to techniques for extracting explanatory variables contributing to a target variable from event data describing components of events.

### BACKGROUND ART

In recent years, development of a system supporting decision making that has been carried out by people with intuition and experience have been growing rapidly by effective use of a large amount of social information called BIG DATA. The fundamental function of many of these decision supporting systems is finding out from the data what are variables (explanatory variable) contributing to variation of the target variable in which users are interested (for example, a variable that a user wants to operate, such as store sales).

As a background art in the present technical field, for example, there is PTL 1 listed below. In this literature, by calculating the degree of contribution of the explanatory variables to the target variable, explanatory variables contributing to the target variable is identified effectively. As a method to calculate the contribution degree, a multiple regression analysis (MR) and a partial least squares regression analysis (PLS) are used.

The explanatory variables are usually extracted from the data table for storing the event data describing a component of the event and its element value. However, these are not always variables themselves stored in the table, and also variables created by performing some kind of processing on the variables stored in the table may be referred to as new explanatory variables. Thus for example, new explanatory variables different from the original variables in temporal and spatial scales are automatically generated to extract the factors with which decision making is easy in various viewpoints without burden on the user.

In the following PTL 2, based on variables stored in the table, new variables are created according to a rule or an aggregation method determined in advance and are added as new explanatory variables. As an example of the rule or the aggregation method, there is an aggregate function for calculating an average every hour when there are variables that represent time series. In the literature, by calculating the degree of contribution of the explanatory variables to the target variable after adding the explanatory variables as described above, explanatory variables effectively contributing to the target variable are identified.

In the following PTL 3, when the value of a certain target variable (plant operation index variable) is predicted by using the value of the explanatory variable group (plant operation condition variables), the value of the target variable is predicted while maintaining a correlation that the explanatory variables mutually have. To be specific, (a) a process of converting the explanatory variable group into explanatory variables that are not correlated to each other and that has less components than the original explanatory variables by using a principal component regression analysis (PCR) or a partial least square regression analysis, which is a linear conversion scheme generally used widely in multivariate analyses; (b) a process of predicting the value of the target variable (using a multiple regression analysis, etc.) from the values of the components; and (c) a process of predicting the values of the explanatory variable group from the values of the components; are implemented. These processes seek the values of the explanatory variable group when the value of the target variable is optimized.

The following NPL 1 describes a learning method to be described hereinafter associated with the present invention.

### CITATION LIST

### Patent Literature

PTL 1: JP 2006-318263 A
PTL 2: JP 2012-27880 A
PTL 3: JP 2012-74007 A

### Non-Patent Literature

NPL 1: Y. Bengio, A. Courville, P. Vincent, “Representation Learning: A Review and New Perspectives”, IEEE Transactions on Pattern Analysis and Machine Intelligence, Vol. 35, No. 8, pp. 1798-1828, 2013

### SUMMARY OF INVENTION

### Technical Problem

In applications that support human decision making by analysis of data, when applying the techniques described in PTLS 1 to 3, there is a problem that each technique can only extract one of explanatory variables contributing to the target variable.

For example, in the cases described in PTLS 1 to 3, when determining the contribution degree of the explanatory variables, (a) a method for obtaining a linear relationship between a target variable and a single explanatory variable, or, (b) a method for determining the linear combination relationship between a target variable and an explanatory variable group is used. In other words, the former represents the quantity relationship between the target variable and the explanatory variable using a certain coefficient a, such as y=ax with respect to the target variable y and the explanatory variable x. The latter represents the quantity relationship between the target variable and the explanatory variable group by using a certain vector P=(p1, p2, . . . pN) such as y=PX (y=p1x1+p2x2+ . . . +pNxN) with respect to the target variable y and a vector X=(x1, x2, . . . xN) of the explanatory variable. A typical analysis technique example of the former is a single regression analysis, and a typical analysis technique example of the latter is a multiple regression analysis, principal component regression analysis and partial least square regression analysis. In this case, the explanatory variable in which coefficients such as a, and p1 . . . pN, become large values, is an explanatory variable effectively contributing to the target variable.

In a system using a method for obtaining a linear combination relationship between the target variable and the explanatory variable as described above, when the combined effects of a plurality of explanatory variables are contributing to variations in the target variable, identifying the combination is difficult. Although it can be also considered that user creates the combination of the explanatory variables manually and determines the contribution degree of the combination, it is considered to be practically impossible because when the number of candidates of explanatory variables increases, the total number of combinations increases dramatically.

The present invention has been made to solve the aforementioned problems, and an object is to efficiently identify a combination of other variables that contribute to variations of the target variable, and to extract it as an explanatory variable (factor).

### Solution to Problem

The factor extraction system according to the present invention defines covariant composite variables composed by the combination of event variables and a binary number indicating whether the combination is present in the event data, and by determining the correlation between covariant composite variables and the target variable, the contribution factors are extracted.

### Advantageous Effects of Invention

According to the factor extraction system according to the present invention, it is possible to automatically identify the combination of a plurality of explanatory variables effectively contributing to the target variable.

### BRIEF DESCRIPTION OF DRAWINGS

FIG. 1 is a diagram schematically illustrating how to extract explanatory variables contributing to the target variable in a conventional method.

FIG. 2 is a diagram for illustrating a processing outline of factor extraction system according to the present invention.

FIG. 3 is a block diagram of the factor extraction system 300 according to Embodiment 1.

FIG. 4 is a diagram illustrating a configuration of the event data table 301 and data examples.

FIG. 5 is a diagram illustrating a configuration of the event variable table 304 and data examples.

FIG. 6 is a diagram illustrating a configuration of the covariant composite variable table 307 and data examples.

FIG. 7 is a diagram illustrating a configuration of the target variable table 302 and data examples.

FIG. 8 is a diagram illustrating a configuration of the contribution variable table 309 and data examples.

FIG. 9A is a diagram illustrating an example of the factor label 311.

FIG. 9B is a diagram illustrating the correspondence relationship between the event variable table 304 and the target variable table 302.

FIG. 9C is a diagram illustrating the correspondence relationship between the event variable table 304 and the factor label image 921.

FIG. 10 is a detailed block diagram of the event variable conversion section 303.

FIG. 11A is a diagram illustrating the correspondence relationship between the event data table 301 and the event variable table 304.

FIG. 11B is another example illustrating the correspondence relationship between the event data table 301 and the event variable table 304.

FIG. 11C is another example illustrating the correspondence relationship between the event data table 301 and the event variable table 304.

FIG. 12 is a flowchart of the process of the event variable conversion section 303 converting the event data table 301 into the event variable table 304.

FIG. 13A is a diagram illustrating a configuration of the covariant composite network 1301.

FIG. 13B is a diagram illustrating an example of the covariant composite network 1301 after learning.

FIG. 14 is a detailed block diagram of the covariant composite variable generation section 305 and the covariant composite variable interpretation section 306.

FIG. 15A illustrates an example in which the key part 3070 of the covariant composite variable table 307 is a character string that represents the combination of coordinates.

FIG. 15B illustrates an example in which the key part 3070 is a character string that is a combination of people and things.

FIG. 15C illustrates an example in which the key part 3070 is a combination of people and things.

FIG. 16 is a diagram illustrating an example of RBM.

FIG. 17 is a flowchart of processing of the covariant composite variable generation section 305 converting the event variable table 304 into the covariant composite variable table 307.

FIG. 18 is a flowchart illustrating the processing of the covariant composite variable interpretation section 306.

FIG. 19 is a flowchart illustrating the processing of the contribution variable selection section 308.

FIG. 20 is a flowchart illustrating the process flow of the factor label output section 310.

FIG. 21 is a detailed block diagram of the covariant composite variable generation section 305 in Embodiment 2.

### DESCRIPTION OF EMBODIMENTS

### <About the Total Number of the Combinations of Explanatory Variables>

Hereinafter, to facilitate the understanding of an object of the present invention, first the total number of combinations of explanatory variables will be described, and then embodiments of the present invention will be described.

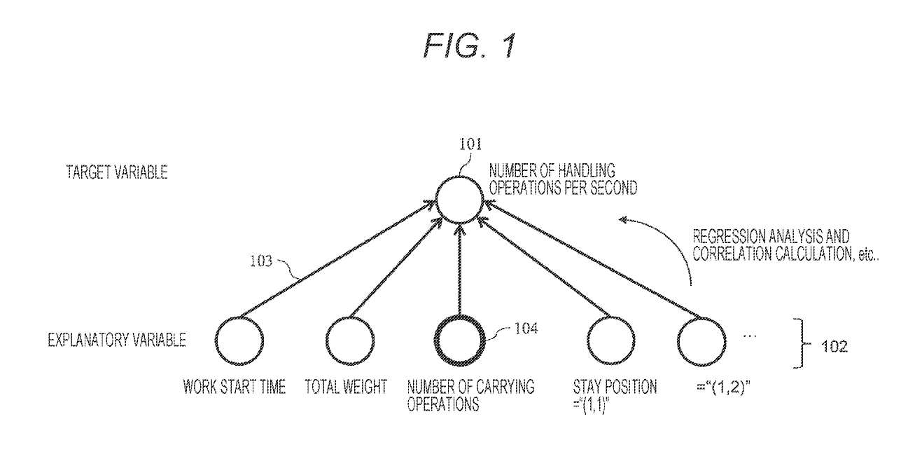

FIG. 1 is a diagram schematically illustrating how to extract explanatory variables contributing to a target variable in a conventional manner. In FIG. 1, explanatory variables contributing to the target variable 101 are extracted from an explanatory variable group 102. A contribution degree 103 is a numerical value representing the strength of contribution of each explanatory variable to the target variable 101. The contribution degree 103 can be determined by a simple linear regression analysis, multiple regression analysis, principal component regression analysis, and partial least square regression analysis, for example. In the example shown in FIG. 1, an explanatory variable 104 which contributes most to the target variable 101 is extracted. In other words, it is shown that the tendency of the linear relationship “number of handling operations per second=coefficient a×number of carrying operations” is strong.

In the scheme shown in FIG. 1, when a combination of a plurality of explanatory variables contributes to variations of the target variable 101, it is not possible to extract the combination as a contribution factor. For example, the case where “when the number of carrying operations and the total weight are both low or both high, the number of handling operations per second is likely to be varied” corresponds to this case. In order to identify a combination of a plurality of explanatory variables whose contribution degree is high, it is necessary to repeat the determination of the contribution degree by actually creating combinations.

If the total number of explanatory variables is about 2 to 3, it is also conceivable to create combinations thereof manually. However, if the total number of explanatory variables is U and the number of variables to be combined is V, the total number of combinations is _{U}C_{V}, and thus it is practically impossible to create combinations manually when U or V is increased (for example, when U=1000 and V=10, the number of combinations will be 2.65×10¹⁴).

In addition, a linear combination represented by y=a1x1+a2x2+a3x3 shows that the linear combination of the three explanatory variables x1 to x3 contributes to the target variable y. However, it should be noted that this represents each contribution degree of the explanatory variables x1, x2 and x3 to the target variable y as each of coefficients a1, a2 and a3, and does not show that the combination of the explanatory variables x1, x2 and x3 contributes to the target variable.

### Embodiment 1

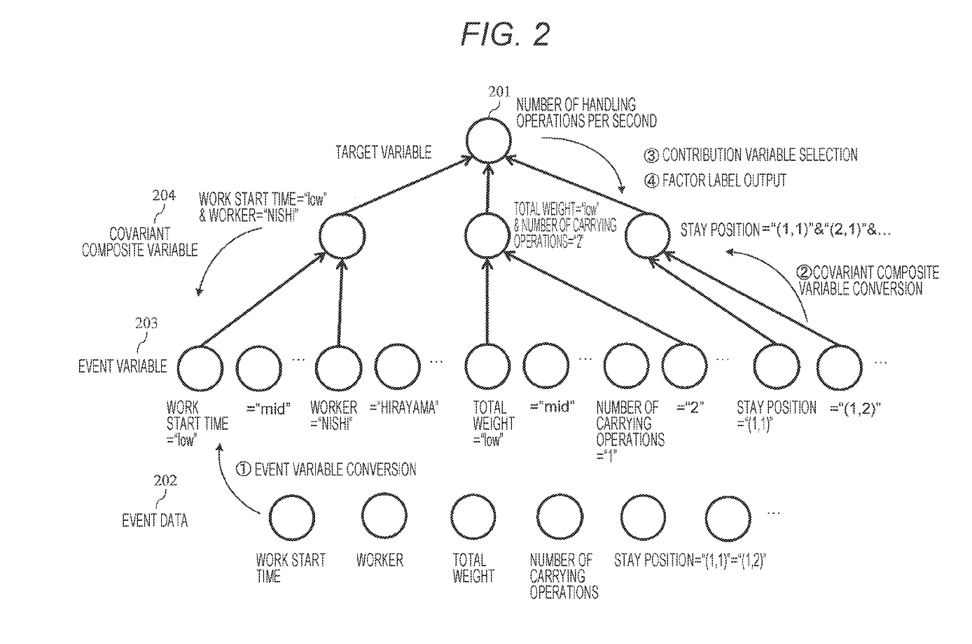

FIG. 2 is a diagram for illustrating a processing outline of a factor extraction system according to the present invention. Here, it is assumed that event data 202 are provided to the system, and explanatory variables (contributing factors) contributing to a designated target variable 201 are extracted.

The event data 202 are data that describe the contents of the event. The event is configured by a combination of one or more sets of the components such as “work start time” and “worker” and an element value of each component (numerical values, character strings, codes (numerical strings treated as character strings), etc.). The event data 202 hold one or more events in the form of a table for example.

In the first step, the system converts the event data 202 into event variables 203. The event variable 203 holds “1” when the event represented by a set of components such as “work start time=“low”” and “worker=“Nishi”” and their element values is written in the event data 202 (the event has occurred) for each set, and holds “0” when it is not written (the event has not occurred).

In the next step, the system converts the event variables 203 into the covariant composite variables 204. Regarding a combination of one or more event variables 203 such as “work start time=“low” and worker=“Nishi””, the covariant composite variable 204 holds “1” when the combination is written in the event data 202 and holds “0” when the combination is not written therein.

In the next step, the system selects the covariant composite variable 204 having a high contribution degree to the target variable 201. In the next step, the system outputs a factor label by using the selected covariant composite variable 204. The factor label referred to herein is a combination of events represented by the covariant composite variable 204, which is expressed as a character string so that the user can easily confirm the selected covariant composite variable 204 visually.

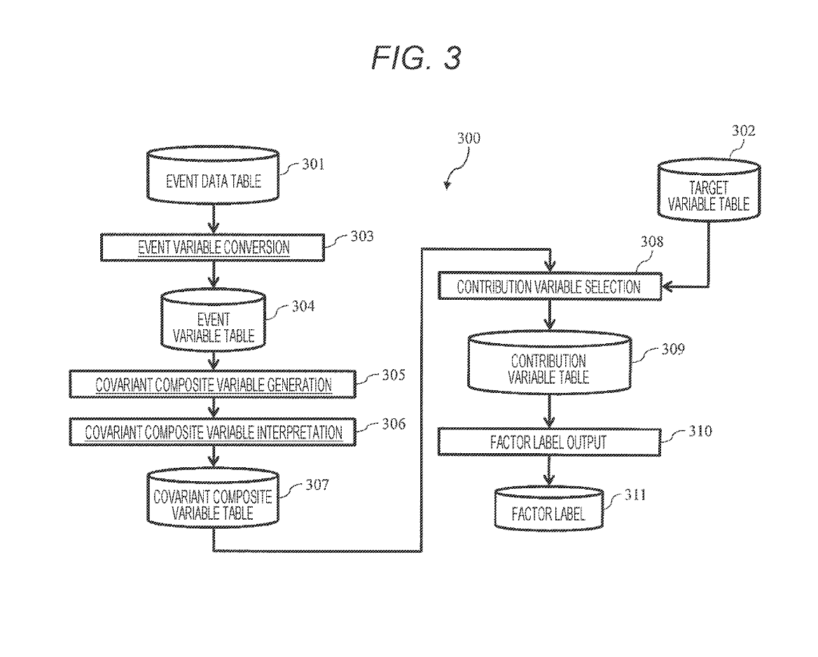

FIG. 3 is a block diagram of a factor extraction system 300 according to Embodiment 1 of the present invention. The factor extraction system 300 includes an event variable conversion section 303, a covariant composite variable generation section 305, a covariant composite variable interpretation section 306, a contribution variable selection section 308, and a factor label output section 310. Further, the factor extraction system 300 generates each table shown in the figures, and stores it in a storage device such as a hard disk as needed. The factor extraction system 300 inputs an event data table 301 and outputs the factor label 311. The following describes each of the components of the factor extraction system 300.

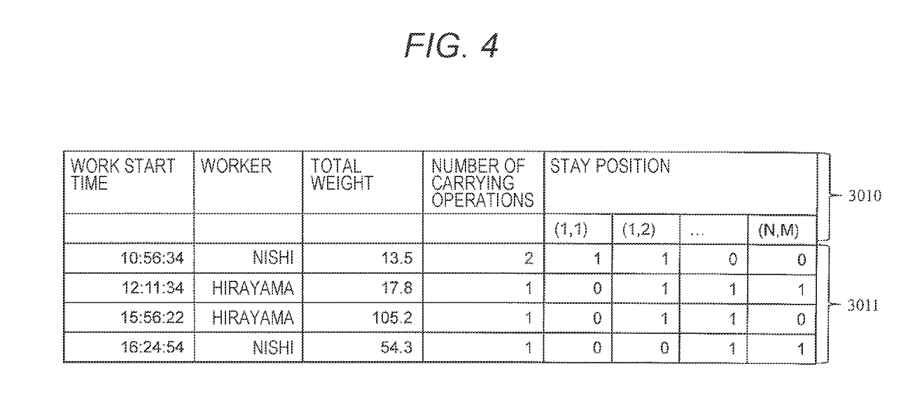

FIG. 4 is a diagram illustrating a configuration of the event data table 301 and data examples. The event data table 301 has a key part 3010 and a value part 3011. The key part 3010 holds character strings representing the meaning of each field (column). The key part 3010 corresponds to the components of the event. The value part 3011 holds character strings, numerical values, codes and the like indicating the value of each field of each record. The value part 3011 corresponds to the element values of the components. One row of the value part 3011 corresponds to one record (one event).

Since the “stay position” of FIG. 4 has columns composed of a plurality of sets of coordinates, the value part 3011 can be constituted by a flow line formed by connecting a plurality of coordinate values. Alternatively, as illustrated in FIG. 4, the similar flow line may be represented by listing all coordinate values of the coordinate space in the key part 3010, and setting only coordinate values where the worker has passed on the flow line to be “1”, and coordinate values where the worker has not passed to be “0”. Hereinafter, the latter is adopted, and regarding the “stay position”, the event data table 301 and an event variable table 304 have the similar data structure for convenience of the processing.

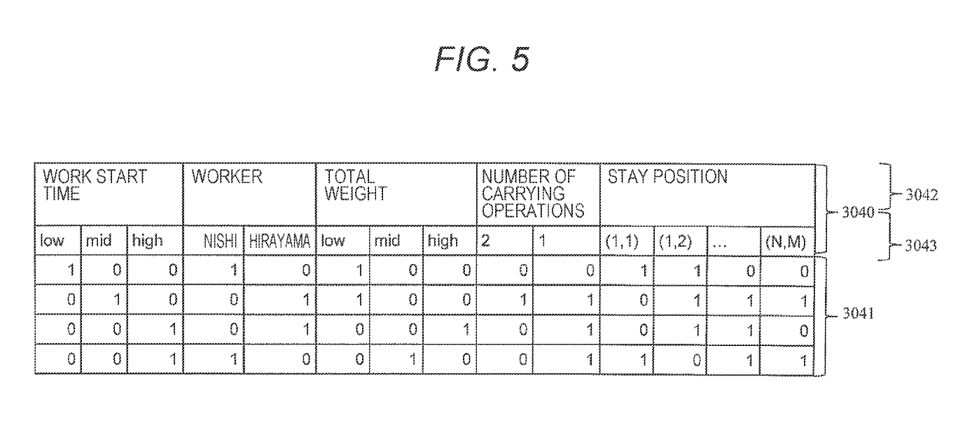

FIG. 5 is a diagram showing a configuration of the event variable table 304 and data examples. The event variable conversion section 303 converts the event data table 301 into the event variable table 304. Details of this process will be described later. The event variable table 304 has a key part 3040 and a value part 3041. The key part 3040 further includes an event name part 3042 and an event value part 3043.

The event name part 3042 and the event value part 3043 are enumerations of the combination of the key part 3010 and the value part 3011 in the event table 301. The combination of, for example, the event name part 3042=“worker” and the event value part 3043=“Hirayama” indicates that the event referred to as “the worker was Hirayama” is described in the event table 301. The combination of the event name part 3042=“stay position” and the event value part 3043=“(1, 1)” indicates that an event referred to as “has passed through the stay position (1, 1)” is described in the event table 301. When the value part 3041 includes numerical values, if all of the numerical values are listed, the number of sections in the event value part 3043 becomes enormous, and thus the values in the value part 3041 may be divided into an appropriate number of ranks. In FIG. 5, the event name part 3042=“work start time” has been aggregated into three sections. This process will be described later.

The value part 3041 holds “1” when the event represented by a combination of the event name part 3042 and the event value part 3043 is written in the event data table 301, and holds “0” when it is not written. In the example shown in FIG. 5, for example, the first record and the fourth record indicate that the event “the worker was Nishi” has occurred, and the second record and the fourth record indicate that the event “the worker was Hirayama” has occurred.

Since the “stay position” in FIG. 5 assumes the data structure of “stay position” in FIG. 4, the “stay position” is described by the same data structure as that of FIG. 4 in accordance with this. In contrast, regarding the “stay position” in FIG. 4, when the value part 3011 is constituted by a flow line formed by connecting a plurality of coordinate values as described above, the event value part 3043 becomes a set of a plurality of coordinate values representing the flow line, and the value part 3041 represents whether the flow line is described in the event data table 301 by using “0” or “1”.

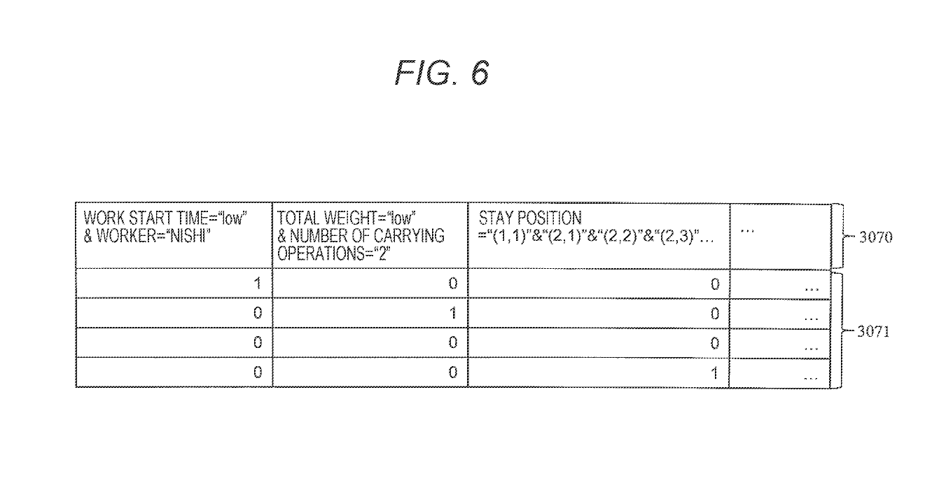

FIG. 6 is a diagram showing a configuration of a covariant composite variable table 307 and data examples. The covariant composite variable generation section 305 and the covariant composite variable interpretation section 306 convert the event variable table 304 into the covariant composite variable table 307. The covariant composite variable is a variable newly introduced in the present invention, and is a variable showing whether a combination of one or more events represented by each record held in the event variable table 304 is present in the event data table 301. Details of the covariant composite variable will be described later. The covariant composite variable table 307 has a key part 3070 and a value part 3071.

The key part 3070 holds a character string in which further one or more sets of the event name part 3042 and the event value part 3043 in the event variable table 304 are combined. The key part 3070 has character strings in which sets of the event name part 3042 and the event value part 3043 are connected using the symbol “&” in a manner such as “work start time”=“low” & “worker”=“Nishi”. However, as the data example shown in the third column, when connecting a plurality of identical sets in the event name part 3042, there is no need to repeat the same event name part 3042. In other words, the expression “stay position”=“(1. 1)” & “(2. 1)” is sufficient without need to express as “stay position”=“(1. 1)” & “stay position”=“(2. 1)”.

The value part 3071 holds “1” when the event represented by the key part 3070 (that is, composite event that combines further one or more events that are represented by a set of the event name part 3042 and the event value part 3043 in the event variable table 304) is written in the event data table 301, and holds “0” when the event is not written.

The contribution covariant selection section 308 converts the covariant composite variable table 307 into a contribution variable table 309 using a target variable table 302 as input parameters. These tables will be described below.

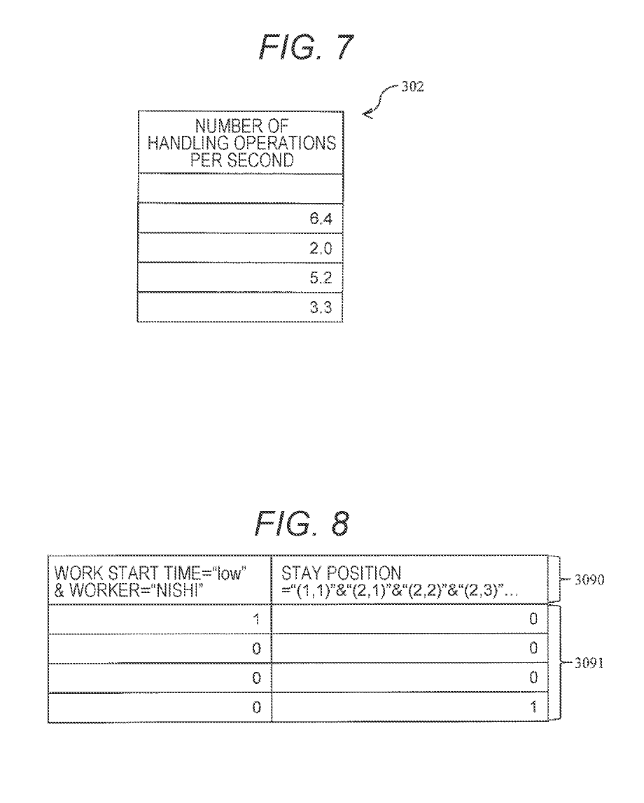

FIG. 7 is a diagram illustrating a configuration of the target variable table 302 and data examples. The target variable table 302 has component extracted to be the target variable (for example, a variable which the user is trying to optimize) among the components (fields) of the events written in the event data table 301. The key part of this table holds a character string indicating the name of the target variable, and the value part holds the value of the variable. The values of the value part are numerical values and can be values of any format such as continuous values and discrete values.

FIG. 8 is a diagram showing a configuration of the contribution variable table 309 and data examples. The contribution variable selection section 308 calculates the contribution degree of covariant composite variables shown in each column of the covariant composite variable table 307 to the target variables shown in each column of the target variable table 302 (one in the case of FIG. 7), and leaves only the covariant composite variable whose contribution degree is equal to or greater than a threshold, and then stores the remainder in the contribution variable table 309. As a contribution degree, for example, a correlation coefficient, and a multiple regression coefficient in a multiple regression analysis can be used. As long as the method can calculate the similarity between two number sequences, other appropriate coefficients may be employed. The contribution variable table 309 has a key part 3090 and a value part 3091 in the same manner as the covariant composite variable table 307.

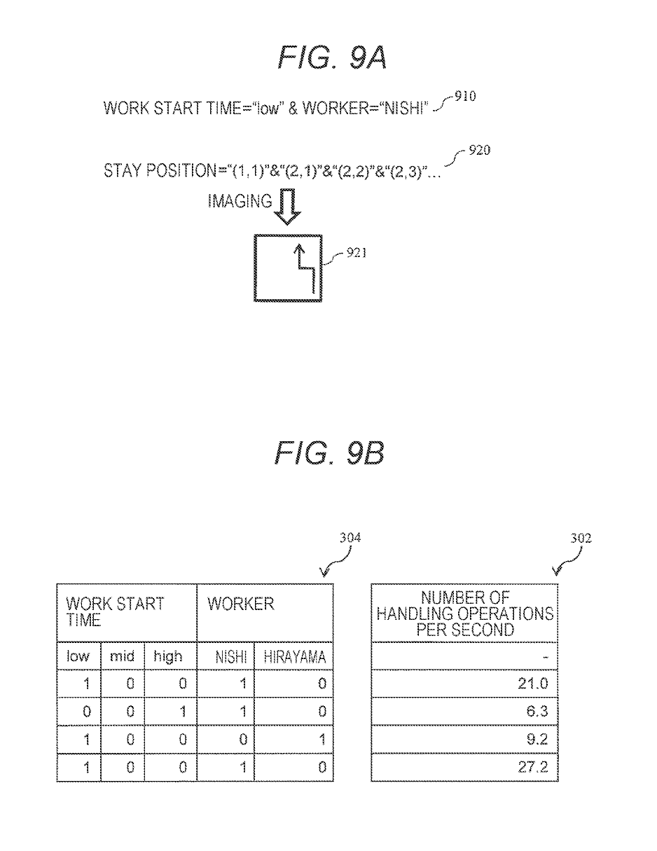

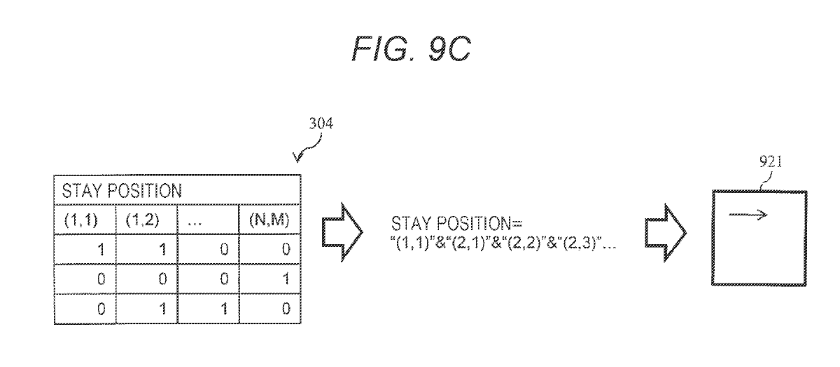

FIG. 9A is a diagram illustrating an example of the factor label 311. The factor label output section 310 generates and outputs the factor label 311 from the key part 3090 of the contribution variable table 309. The factor label 311 is a character string representing the event having a high contribution degree to the target variable 201 and is obtained by outputting the character strings held in the key part 3090 of the contribution variable table 309 for each column.

A factor label character string 910 in FIG. 9A is obtained by outputting the first column of the key part 3090, and a factor label character string 920 is obtained by outputting the second column of the key part 3090. The factor label 311 further can be output for example in an image format. A factor label image 921 is obtained as an image showing a movement route, by connecting the coordinate values corresponding to the contents of the event value part 3043 among the factor label character strings 920 with line segments. Outputting the factor label 311 in an image format as required makes it easy for a user who views the factor label 311 to understand what kind of event it is.

FIG. 9B is a diagram showing the correspondence relationship between the event variable table 304 and the target variable table 302. According to the factor label character string 910 illustrated in FIG. 9A, the event “work start time=“low” and worker=“Nishi”” indicates that it has a high contribution degree to the target variable. This represents “the worker called Nishi has a high work efficiency in the morning”. This suggests that in the record in which the value part 3041 corresponding to these events is 1 in the event variable table 304, the corresponding numerical value in the target variable table 302 is also favorable. In other words, it can be said that adjusting the “work start time” as a control variable for the “worker” has been shown to be capable of improving the target variable.

FIG. 9C is a diagram illustrating the correspondence relationship between the event variable table 304 and the factor label image 921. When the event variable table 304 represents the stay position coordinates of the worker, by displaying it as a factor label image 921, it is easy to see that the combination of events represents the flow line of the worker. Hence, combination of stay positions which are local events represents the comprehensive event that is a flow line and that can be further easily understood by imaging.

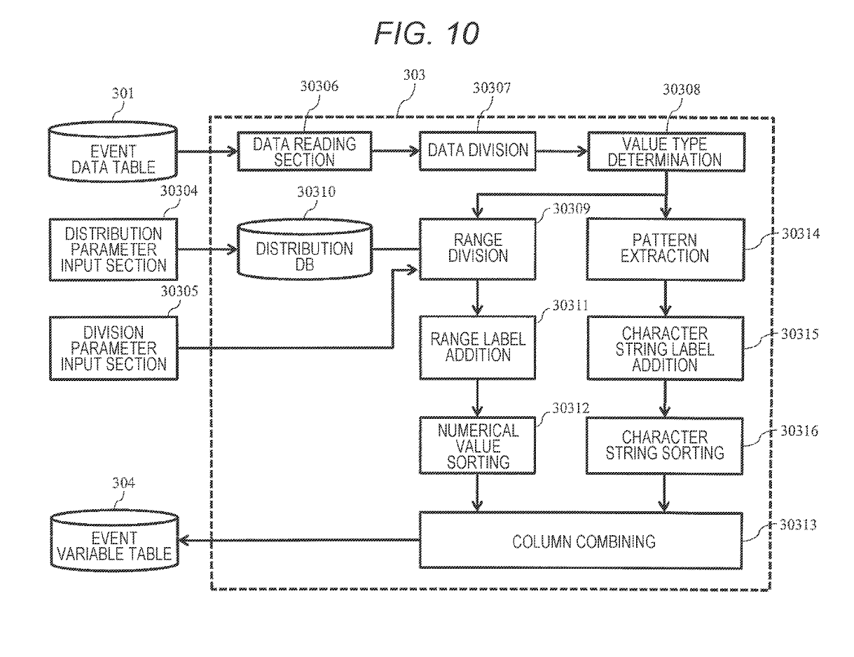

FIG. 10 is a detailed block diagram of the event variable conversion section 303. The event variable conversion section 303 has a data reading section 30306, data dividing section 30307, value type determination section 30308, range dividing section 30309, distribution data base (DB) 30310, range label adding section 30311, numerical value sorting section 30312, column combining section 30313, pattern extraction section 30314, character string label adding section 30315 and character string sorting section 30316. A distribution parameter input section 30304 is connected to the distribution DB 30310, and a division parameter input section 30305 is connected to the range dividing section 30309. These input sections may be configured as a part of the event variable conversion section 303.

The data reading section 30306 reads the event data table 301, and sends it to the data dividing section 30307. The data dividing section 30307 divides the event data into respective column sections, and sends these to the value type determination section 30308.

The value type determination section 30308 determines which one of numerical value, character string and code is the value of each column. The data judged to be numerical value is sent to the range dividing section 30309, and data judged to be a character string or a code is sent to the pattern extraction section 30314. For example, when the data contains an Arabic numeral or a symbol representing a numerical value (−(minus sign), +(plus sign), i (code indicating an imaginary number), decimal point, and square root, etc.), the data can be regarded as a numerical value, and when the data contains a character, it can be regarded as a code. Further, as described later, by comparing the event data with the distribution function, and when being close to the distribution function, the event data can be regarded as a numerical value.

The range dividing section 30309 refers to the distribution DB 30310, and divides the data received from the value type determination section 30308 into ranges (classes). The distribution DB 30310 stores parameters representing the distribution profile of a typical distribution function such as a normal distribution, Laplace distribution, logistic distribution. The user can input parameters of this distribution shape via the distribution parameter input section 30304. The distribution parameter means the average value μ and variance value σ, in the case of a normal distribution. In the case of a Poisson distribution, the distribution parameter is an expected number of occurrences λ of events that occur in a predetermined interval. Parameters indicating how many pieces the data should be divided into can be input through the division parameter input section 30305. To be more specific, it is possible to take a method such as (a) defining the number of sections so that the number of event data contained in each divided section is equal to one another, (b) calculating the average value and the variance value of the event data, and dividing the data based on the average value and the variance value, (c) dividing the data into sections by using the value designated by the user as a separator of the sections, or (d) equally dividing the value range of event data.

The range label adding section 30311 adds a range label for each of the divided sections that the range dividing section 30309 has divided. The steps to add a range label will be described later. The numerical value sorting section 30312 allocates the event data that the value type determination section 30308 has determined as a numerical value into an appropriate range label, and sends the data to the column combining section 30313. The column combining section 30313 combines and stores respective columns in the event variable table 304. The processing by the column combining section 30313 corresponds to combining the three columns of the event value part 3043=“low” to “high” to make the combination correspond to a single event name part 3042 when described with reference to the example shown in FIG. 5.

The pattern extraction section 30314 scans the event data in the row direction, and extracts character strings/code patterns of the same writing. The character string label adding section 30315 adds a character string label to the character strings/code patterns extracted by the pattern extraction section 30314. The process of adding a character string label will be described later. The character string sorting section 30316 associates the event data that the value type determination section 30308 has judged as a character string/code with an appropriate character string/code pattern, and sends the event data to the column combining section 30313. The column combining section 30313 stores the data in the event variable table 304 after combining the columns similarly to in the case of numerical values.

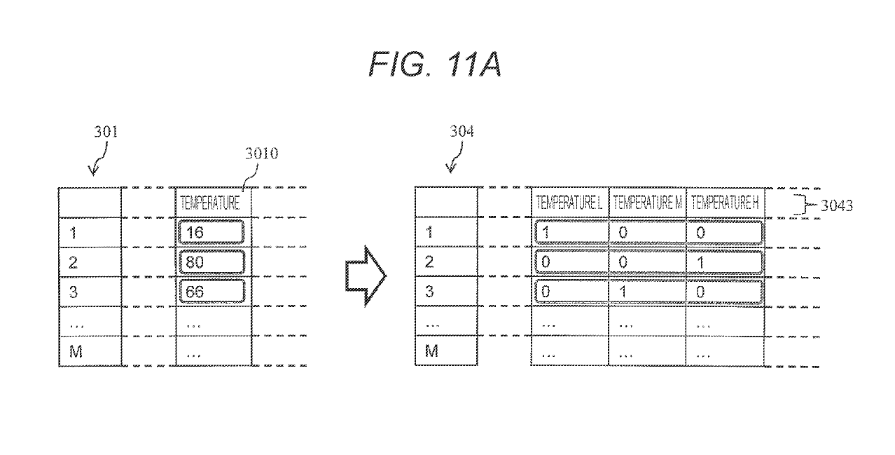

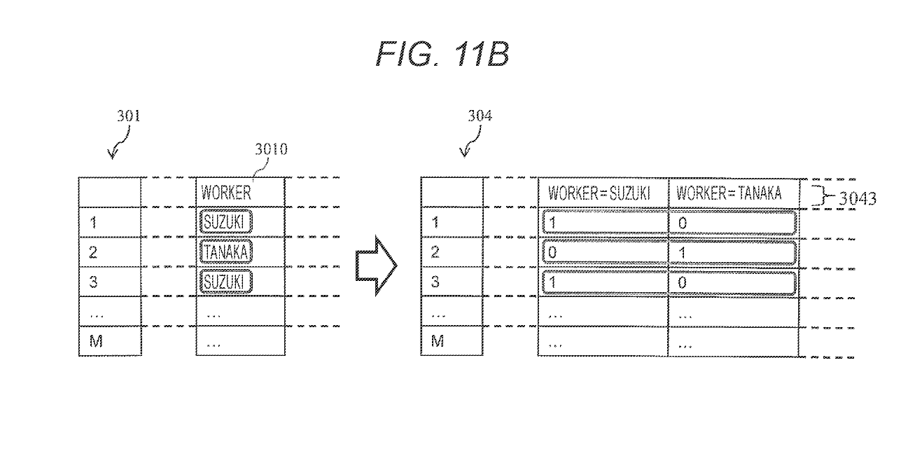

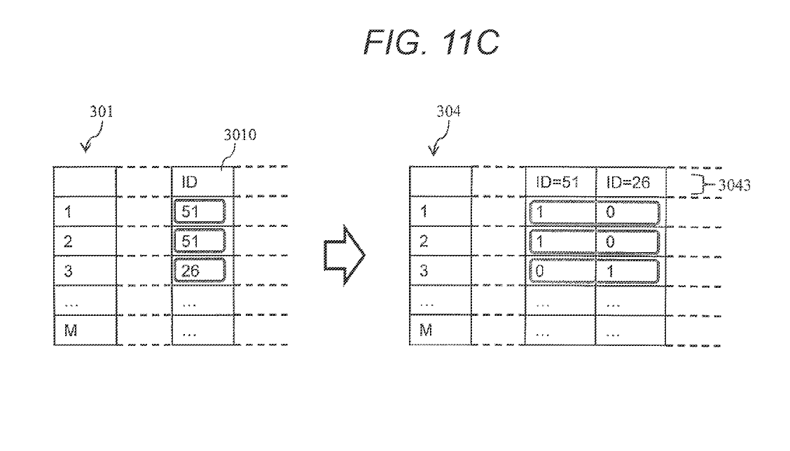

FIG. 11A is a diagram illustrating the correspondence relationship between the event data table 301 and the event variable table 304. Here, data examples that the value type determination section 30308 judges to be numerical values are cited.

In the example shown in FIG. 11A, the key part 3010 of the event data table 301 indicates the component of “temperature”. The value part 3011 of the record 1 indicates 16, the value part 3011 of the record 2 indicates 80, and the value part 3011 of the record 3 indicates 50, and totally M records are stored. On the other hand, the event value part 3043 of the event variable data 304 has three components “temperature L”, “temperature M”, and “temperature H”. Each record in the event variable table 304 corresponds to each record in the event data table 301. That is, the event variable conversion section 303 divides the each value of the value part 3011 in each record in the event data table 301 into three ranges and sets the value part 3041 corresponding to the range to which each record belongs to be 1, and the other value part 3041 to be 0.

The procedure to divide each value of the value part 3011 shown in FIG. 11A into ranges will be described. The user can indicate to divide the value part 3011 whose key part 3010=“temperature” into three sections 0≦X<33, 33≦X<66, and 66≦X≦100 in advance through the division parameter input section 30305. In addition, the labels “temperature L”, “temperature M”, and “temperature H” which are labels of each section given by the range label adding section 30311 can also be indicated together with the above. Therefore, the value “16” comes to belong to “temperature L”, “80” to “temperature H”, and “50” to “temperature M” respectively.

FIG. 11B is another example showing the correspondence relationship between the event data table 301 and the event variable table 304. Here, data examples which the value type determination section 30308 judges to be character strings are cited.

In the example shown in FIG. 11B, the key part 3010 shows a component which is “worker”. The value part 3011 included in this column has “Suzuki”, “Tanaka” and “Suzuki”, which are all composed of character strings. The pattern extraction section 30314 extracts the two character string patterns “Suzuki” and “Tanaka” by removing the duplicate elements. The character string label adding section 30315 generates the event value part 3043 that has two character strings label “worker=Suzuki” and “worker=Tanaka”. The character string sorting section 30316 sets the value part 3041 having the event value part 3043 corresponding to each value part 3011 in the event data table 301 to be 1, and other value part 3041 to be 0.

FIG. 11C is another example showing the correspondence relationship between the event data table 301 and the event variable table 304. Here, data examples which the value type determination section 30308 judges to be codes are cited. In the example shown in FIG. 11C, the same processing as FIG. 11B is performed.

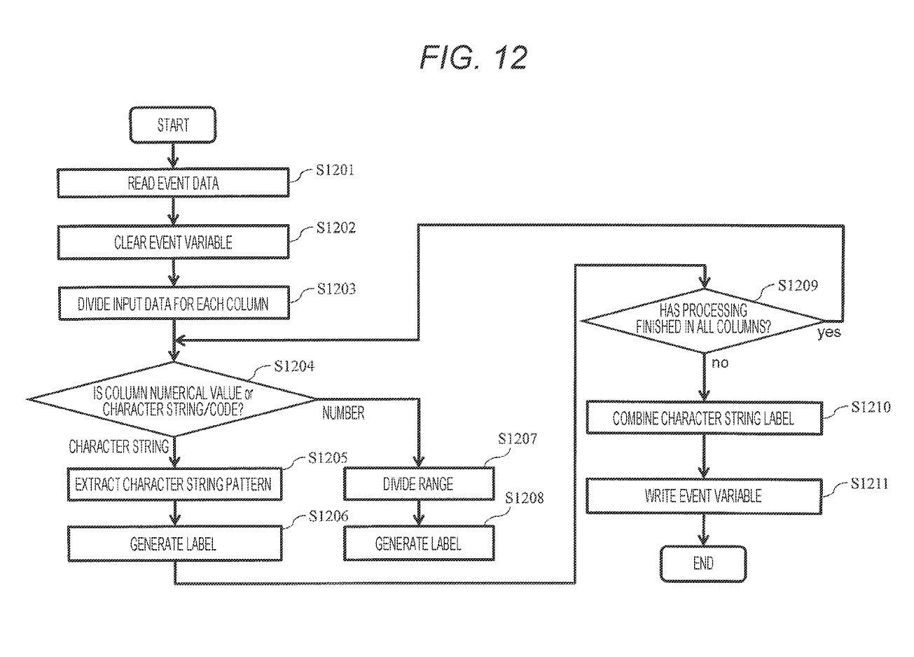

FIG. 12 is a flowchart of processing in which the event variable conversion section 303 converts the event data table 301 into the event variable table 304. The following describes each step in FIG. 12.

### (FIG. 12: Step S1201 to S1202)

The data reading section 30306 reads the event data table 301 (S1201). The data reading section 30306 clears variables containing the result of the conversion, that is, sets the number of rows to 0, and the number of columns to 0 (S1202).

### (FIG. 12: Step S1203)

The data dividing section 30307 divides the event data into sections of respective columns. The data dividing section 30307 substitutes the number of the divided columns for the variable N, and substitutes the length of one column (=number of event data=number of records) for the variable M. The data dividing section 30307 initializes the variable i for counting the columns.

### (FIG. 12: Step S1204)

The value type determination section 30308 scans the i-th column of the event data in the row direction, and determines whether elements contained in the column are all numerical values, or composed of character strings/codes. When all of the elements are composed of numerical values, the process proceeds to the step S1207, and when the elements are composed of character strings or codes, the process proceeds to the step S1205.

### (FIG. 12: Step S1205 to S1206)

The pattern extraction section 30314 extracts character string patterns (or code patterns), by removing duplicate elements from the value part 3011 of each column (S1205). The character string label adding section 30315 generates a character string label based on the extracted result (S1206).

### (FIG. 12: Step S1207 to S1208)

In accordance with the method exemplified in FIG. 11A, the range dividing section 30309 divides the value part 3011 of each column into ranges (S1207), and the range label adding section 30311 assigns a character string label to each section (S1208).

### (FIG. 12: Step S1209)

The numerical value sorting section 30312 (or the character string sorting section 30316) increments the column number i by 1, and determines whether the value i is equal to or smaller than the number of columns N of the event data table 301. The process returns to the step S1204 when i is N or less (unprocessed rows remain), and the process proceeds to the step S1210 when the process has finished for all columns.

### (FIG. 12: Step S1210 to S1211)

The column combining section 30313 sequentially combines character string labels in the lateral direction, and stores them in the event variable table 304. The column combining section 30313 stores the combined event variables in the event variable table 304. Incidentally, a procedure for generating the character string labels in the steps S1206 and S1208 and a procedure for combining the character string labels in the step S1210 have been described; however, a character string labels may be generated and simultaneously combined to the event variable, and sets of event variables and character string labels may be sequentially extended in the column direction.

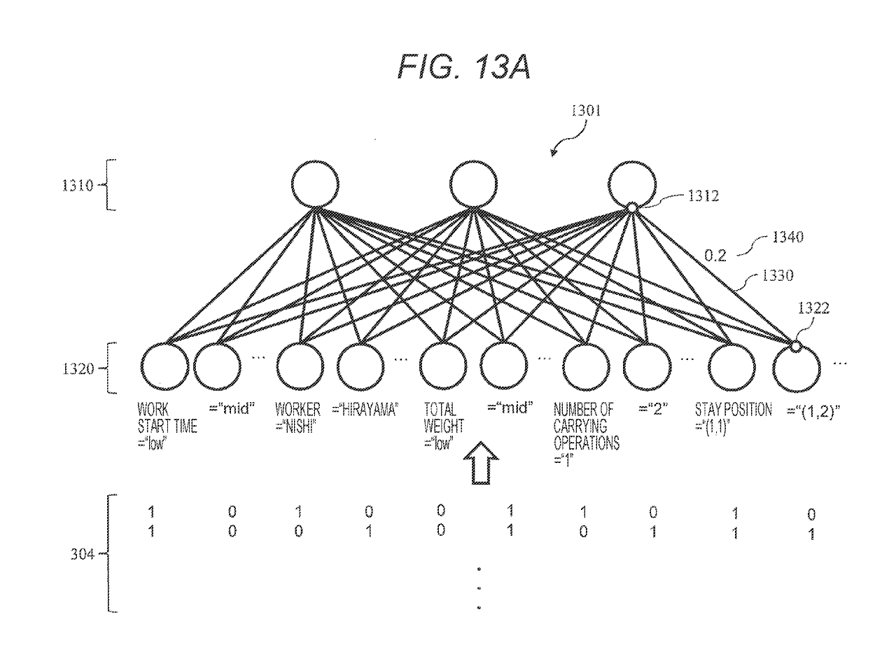

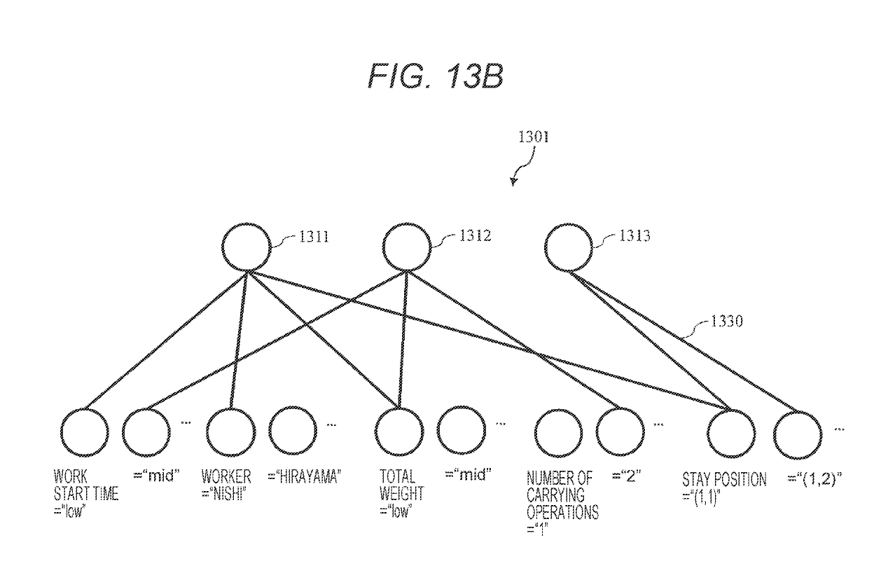

FIG. 13A is a diagram showing a configuration of a covariant composite network 1301. The covariant composite variable generation section 305 and the covariant composite variable interpretation section 306 convert the event variable table 304 into the covariant composite variable table 307 by using the covariant composite network 1301 illustrated in FIGS. 13A and 13B. Hereinafter, with reference to FIGS. 13A and 13B, the covariant composite network 1301 and the conversion procedure using this network will be described.

The covariant composite network 1301 is a network for machine learning in which a plurality of nodes are connected by weighted links and has a covariant composite node group 1310 and the event node group 1320. The covariant composite node group 1310 has covariant composite nodes whose number is determined by the user in advance. The event node group 1320 has event nodes whose number is equal to the number of columns in the event variable table 304. The covariant composite node and the event node are variable nodes each of which has a value 0 or 1. Each record value of the event variable table 304 is put into the event node group 1320, and the covariant composite network 1301 executes the machine learning as described below using the record values.

Each covariant composite node is coupled to all of the event node via composite links 1330, and each event node is coupled to all of the covariant composite nodes via the composite links 1330. The number of the composite links 1330 is A×B, when the number of covariant composite nodes is A, and the number of event nodes is B. The composite link 1330 has a composite weight value 1340 showing the coupling strength between the covariant composite node and the event node.

Each of the covariant composite nodes has a covariant composite node bias value 1312 that indicates the probability that the covariant composite node becomes 1. Each event node has an event node bias value 1322 that indicates the probability that the event node becomes 1. For convenience of description, the bias value is illustrated for only each rightmost node in FIGS. 13A and 13B.

The covariant composite network 1301 has a machine learning mechanism performed by mutual calculation for calculating the value of the covariant composite node group 1310 from the value of the event node group 1320 and for calculating the value of the event node group 1320 from the value of the covariant composite node group 1310. In other words, when the event variable data is input for the event node group 1320 from each row of the event variable table 304, by means of calculation using the value of the event node group 1320, as well as the composite weight 1340 and covariant composite node bias 1312 which each event node has, the value of the covariant composite node group 1310 is determined, and each covariant composite node has the value 0 or 1. Further, as a reverse calculation, by calculation using the value of the covariant composite node group 1310, as well as the composite weight 1340 and the event node bias 1322 which each covariant composite node has, the value of the event node group 1320 is determined and each of the event nodes has the value 0 or 1.

As the machine learning progresses, when the event node or a combination of a plurality of event nodes has a strong tendency to be 1, a covariant composite node connected to the event node or a combination of the plurality of event nodes also converges to 1 accordingly. Each column in the event variable table 304 indicates whether an event represented by the column is present in the event data table 301 (that is, whether the event has occurred), and therefore when the value of the covariant composite node is 1, it is indicated that the events represented by each column in the event variable table 304 which is connected to this happen at the same time. That is, the covariant composite node becomes 1 when a combination of events represented by the connected event node is present, and it becomes 0 when the combination is not present.

Machine learning of the tendency of the event variable table 304 using the covariant composite network 1301 may generate a covariant composite variable representing a combination of events. This covariant composite variables is desirable to be configured to represent the combination of events that frequently occur mutually. In other words, under conditions that a covariant composite node is constituted by a combination of a plurality of event nodes which often have the value 1 mutually, the composite weight 1340, covariant composite node bias 1312, and event node bias 1322 need to be adjusted by machine learning.

As a machine learning technique for implementing the above, there is a method in which the value of the covariant composite node group 1310 is calculated by using the mechanism of mutual calculations between the covariant composite node group 1310 and the event node group 1320 when a record of event variable table 304 is input to the event node group 1320, and further the value of the event node group 1320 is mutually calculated again, and then each of the above parameters are adjusted so that values of the event node group 1320 that has been input and the resulting value of the mutual calculation of the event node group 1320 is the same. As a specific technique, generally the self-organizing machine learning system is well known, and a restricted Boltzmann Machine is used for example in the present embodiment.

FIG. 13B is a diagram illustrating an example of the covariant composite network 1301 after learning. By utilizing the fact that the composite weight 1330 having a low value has a small influence on the behavior of the network 1301, the composite link 1330 having the composite weight 1330 smaller than a certain threshold is deleted. In this example, by the results of machine learning, a covariant composite node 1311 is constituted by a combination of event nodes “work start time=“low””, “worker=“Nishi””, and “stay position=“(1, 1)””, and the covariant composite node 1312 is constituted by a combination of event nodes “work start time=“mid””, “total weight=“low”” and “number of carrying operations=“2””, and a covariant composite node 1313 is constituted by a combination of event nodes “stay position=“(1, 1)”” and “stay position=“(1, 2)””.

Although in the present Embodiment 1, RBM is used for learning covariant composite parameters, other learning techniques may also be used as long as the state of (0, 1) of the event node group and the state of (0, 1) of the covariant composite node can be mutually calculated uniquely in the techniques and the techniques are methods for learning the parameters so that the difference is reduced between the value of the event node group 1320 that has been input and the resultant value of the event node group 1320 mutually calculated. For example, an auto encoder can also be used.

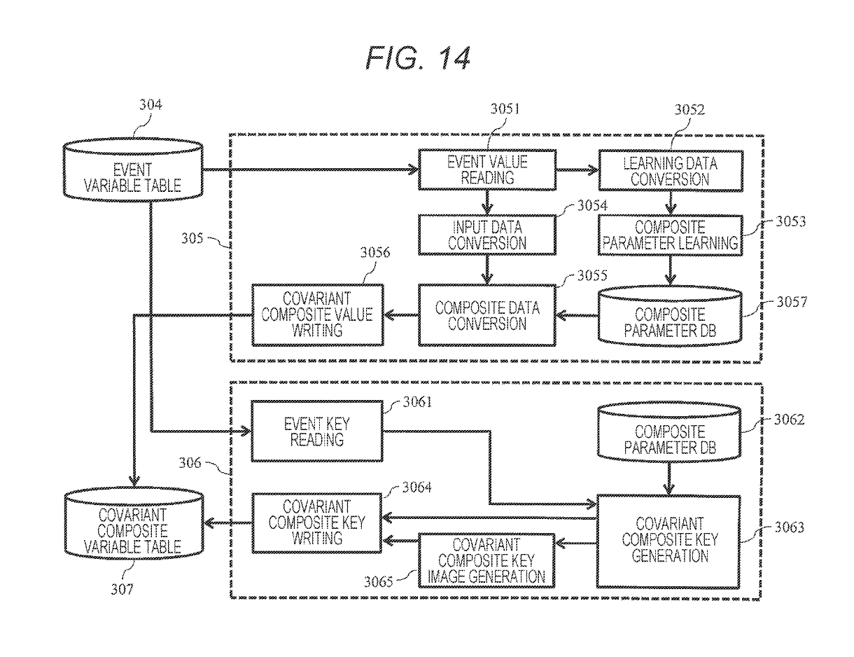

FIG. 14 is a detailed block diagram of the covariant composite variable generation section 305 and the covariant composite variable interpretation section 306. In FIG. 14, although composite parameter DB s 3057 and 3062 are divided for convenience of description, these may be shared between the covariant composite variable generation section 305 and the covariant composite variable interpretation section 306.

An event value reading section 3051 reads the value part 3041 of the event variable table 304, which is an input for the covariant composite variable generation section 305.

A learning data conversion section 3052 converts a value stored in the value part 3041 into vector data for machine learning. To be specific, the k-th row of the value part 3041 is converted into the learning vector data xₖ=(xₖ₁, . . . x_{kN}) in which the value of the i-th column is xₖᵢ (N is the number of columns in the table, k=1 to R, and R is the number of rows in the table). The learning vector data xₖ are created equivalently to the number of rows R in the table.

A composite parameter learning section 3053 calculates composite parameters of the covariant composite network (=composite weight 1340, covariant composite node bias 1312, and event node bias 1322). In the present Embodiment 1, the section calculates the composite parameters in accordance with the RBM learning rule. The learning rule of RBM will be described later.

An input data conversion section 3054 converts the value part 3041 into vector data for conversion thereof into the value part 3071 of the covariant composite variable table 307.

Specifically, using the same function as the learning data conversion section 3052, the value part 3041 is converted into yₖ=(yₖ₁, . . . y_{kN}) (N is the number of columns in the table, k=1 to R, R is the number of rows in the table). The input vector data yₖ are created equivalently to the number of rows in the table.

A composite data conversion section 3055 converts the value part 3041 into the value part 3071 of the covariant composite variable table 307, by using the composite parameter DB 3057 and the vector data yₖ obtained from the input data conversion section 3054. The forward calculation rule of the RBM is used as the conversion rules. The forward calculation rule of the RBM will be described later. A covariant composite value writing section 3056 stores the value part obtained by the conversion in the value part 3071 of the covariant composite variable table 307.

An event key reading section 3061 reads the key part 3040 of the event variable table 304.

A covariant composite key generation section 3063 generates the key part 3070 of the covariant composite variable table 307, by using the read key part 3040 and the composite parameter DB 3062. The key part 3070 is generated by connecting the key part 3040 to be combined as a character string with a delimiter “&”. Which event variables are combined to generate the covariant composite variable can be determined using a reverse calculation rule of the RBM. The reverse calculation rule of the RBM will be described later.

A covariant composite key image generation section 3065 images character strings that can be imaged out of the character strings of the key part 3070 which the covariant composite key generation section 3063 has generated. Hereinafter, this image is referred to as a key image. Examples of the image processing will be described later. A covariant composite key writing section 3064 writes the generated key part 3070 and the key image in the key part 3070 of the covariant composite variable table 307.

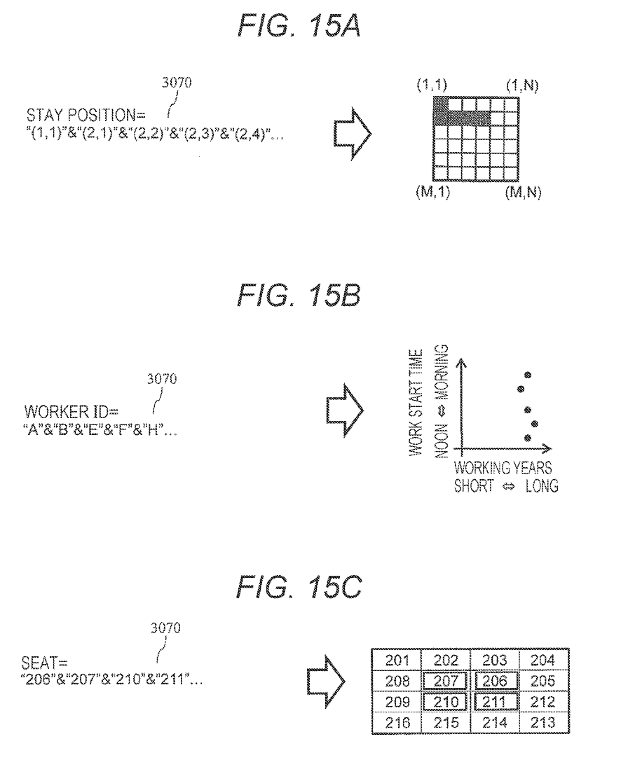

FIG. 15A shows an example in which the key part 3070 of the covariant composite variable table 307 is a character string that represents the combination of coordinates. The covariant composite key image generation section 3065 generates a key image made by filling the pixel corresponding to the coordinates that are present in the character string. According to this example, by displaying an image of a combination of position coordinates where the worker stayed, for example, it is easily understood that a combination of the coordinates means an L-shaped flow line.

FIG. 15B shows an example in which the key part 3070 is a character string that is a combination of people and things. The covariant composite key image generation section 3065 generates the key image obtained by plotting the people and things that the key part 3070 contains, regarding the attributes of the people and things as respective axes of the graph. According to this example, by arranging for the working years and the work start time which are attributes of a worker to be the axes of the graph, it is easily understood that the key part 3070 means a group of workers with long working years.

FIG. 15C is an example in which the key part 3070 is a combination of people and things. The covariant composite key image generation section 3065 generates a key image in which a person and a thing included in the key part 3070 are plotted on a map when there is map information on the position of the person and the thing. According to this example, it is easily understood that the key part 3070 means a seating group in the central area section by using a seating chart as map information.

Hereinafter, the learning rule of the RBM, forward calculation rule, and reverse calculation rule will be described. The details have been described in NPL 1 for example. Here, a minimum description necessary to describe the process of the covariant composite variable generation section 305 and the covariant composite variable interpretation section 306 will be made.

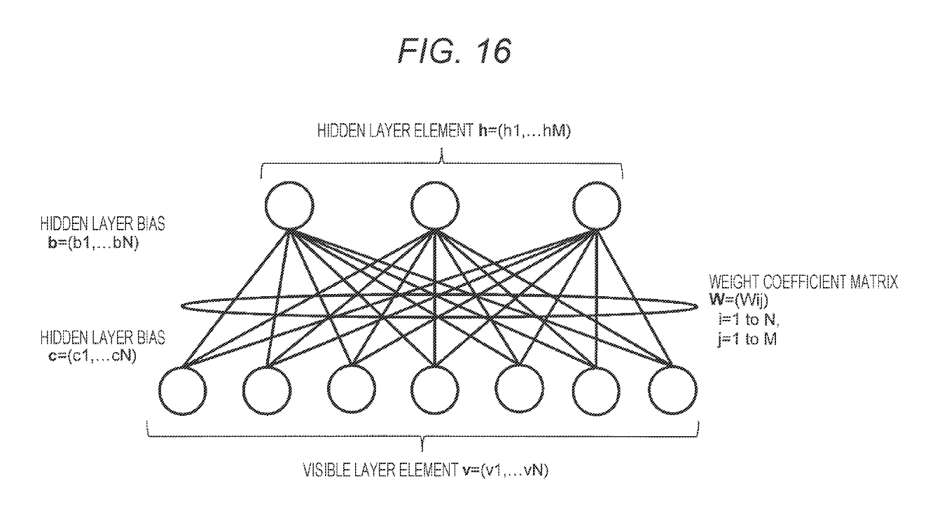

FIG. 16 is a diagram illustrating an example of the RBM. The RBM is a neural network as shown in FIG. 16. A visible layer element v=(v₁, . . . v_{N}) and a hidden layer element h=(h₁, . . . h_{M}) are random variable vectors for data input and output, and a weight coefficient matrix W=(Wᵢⱼ), hidden layer bias b=(b₁, . . . b_{L}), and visible layer bias c=(c₁, . . . c_{N}) are parameters. The values of the visible layer element v and the hidden layer element h can be calculated mutually by the following Equations (1) and (2).

P(vᵢ=1|h)=σ(cᵢ+ΣⱼWᵢⱼhⱼ),i=1 to N (1)

P(hⱼ=1|v)=σ(bⱼ+ΣᵢWᵢⱼvᵢ),j=1 to M (2)

σ(x)=1/(1+exp(−x)) (3)

Equation (1) is the reverse calculation rule of the RBM, and Equation (2) is the forward calculation rule of the RBM.

The weight coefficient matrix W, hidden layer bias b, and visible layer bias c, which are parameters, are obtained from the iterative calculation by applying the learning vector data xₖ to the visible layer element v according to the following Equations (4) to (6).

Wᵢⱼ=Wᵢⱼ+ηΔWᵢⱼ (4)

bᵢ=bᵢ+ηΔbᵢ (5)

cⱼ=cⱼ+ηΔcⱼ (6)

The symbol η represents a learning coefficient. The update amounts ΔWᵢⱼ, Δbᵢ, and Δcⱼ are obtained by the following Equations (7) to (9).

ΔWᵢⱼ=P(hⱼ=1|v)vᵢ−P(hᵢ=1|v̂)v̂ᵢ (7)

Δbᵢ=vᵢ−v̂ᵢ (8)

Δcⱼ=P(hⱼ=1|v)−P(hⱼ=1|v̂) (9)

The symbol v̂ᵢ represents a value of the visible layer element when the transition of the value vᵢ of the visible layer element is performed once by using Equations (1) and (2). The equation v̂=(v̂ᵢ, . . . , v̂_{N}) is satisfied. Equations (4) to (9) are included in the learning rule of the RBM.

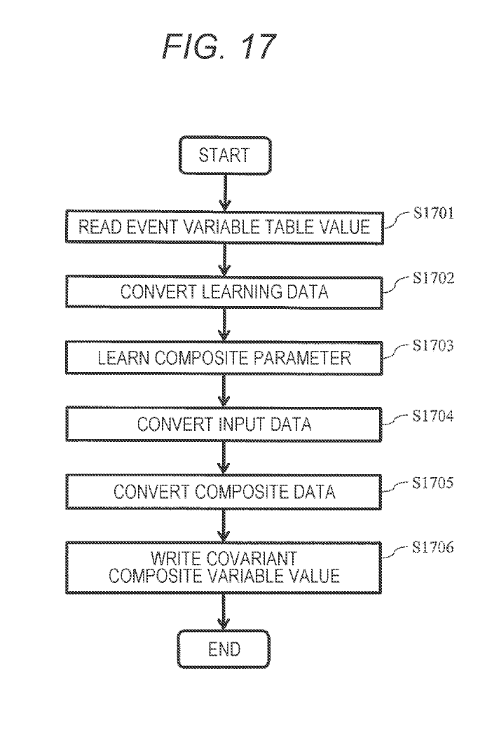

FIG. 17 is a flowchart of a process of the covariant composite variable generation section 305 converting the event variable table 304 into the covariant composite variable table 307. The following describes each step in FIG. 17.

### (FIG. 17: Step S1701 to S1702)

The event value reading section 3051 reads the value part 3041 of the event variable table 304 (S1701). The learning data conversion section 3052 converts the read value in the table into vector data xₖ for composite parameter learning.

### (FIG. 17: Step S1703)

The composite parameter learning section 3053 calculates the composite parameters (=composite weight 1340, covariant composite node bias 1312, and event node bias 1322). Specifically, by applying the learning vector data xₖ to the visible layer elements v which is an input of the above Equations (4) to (9), the composite parameter learning section 3053 obtains the composite parameters W, b and c by iterative calculation of Equations (4) to (9). The obtained composite parameters are stored in the composite parameter DB 3057.

### (FIG. 17: Step S1704)

The input data conversion section 3054 converts the value part 3041 into vector data for converting the value part into the value part 3071 of the covariant composite variable table 307. To be specific, the input vector data yₖ is generated.

### (FIG. 17: Step S1705)

The composite data conversion section 3055 converts the input vector data yₖ generated in the step S1705 into the covariant composite vector data. More specifically, the composite data conversion section 3055 receives the value of the hidden layer element h obtained by applying the input vector data yₖ to the visible layer element v, which is an input of the above formula (2), as the covariant composite vector data dₖ=(dₖ1, . . . d_{kM}) (k=1 to R).

### (FIG. 17: Step S1706)

The covariant composite value writing section 3056 writes the covariant composite vector data dₖ obtained in the step S1705, in the value part 3071 of the covariant composite variable table 307. To be specific, the writing section writes the dₖ in the k-th row of the value part 3071. In this case, the value in the j-th column of the k-th row is represented as dₖⱼ.

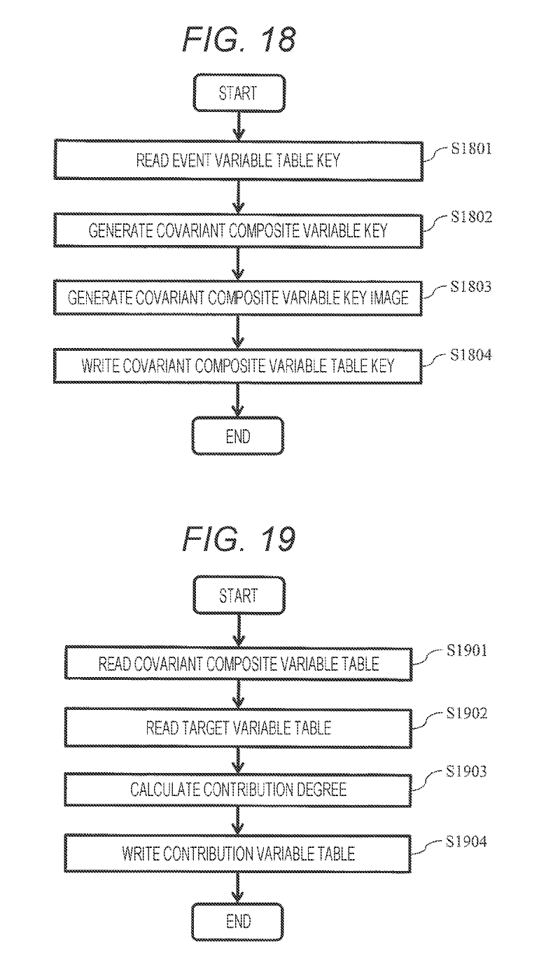

FIG. 18 is a flowchart for illustrating the process of the covariant composite variable interpretation section 306. The following describes each step in FIG. 18.

### (FIG. 18: Step S1801)

The event key reading section 3061 reads the key part 3040 from the event variable table 304.

### (FIG. 18: Step S1802)

The covariant composite key generation section 3063 generates the key part 3070 of the covariant composite variable table 307. The key part 3070 is generated by connecting character strings in the key part 3040 of the event variable group that constitutes the covariant composite variables. Which event variable groups are combined to constitute a certain covariant composite variable can be determined using Equation (1) of the reverse calculation rule of the RBM.

### (FIG. 18: Step S1802: Supplement)

Assume that we want to know which event variables are combined to constitute the covariant composite variable of the j-th column in the covariant composite variable table 307. At this time, a vector in which only the j-th element is “1” and the rest are “0” is applied to the hidden layer element h which is an input of Equation (1). The event variable group corresponding to the element which is “1” in the resulting visible layer elements v is the event variable constituting the covariant composite variable.

### (FIG. 18: Step S1803 to S1804)

The covariant composite key image generation section 3065 generates a key image regarding any one which can be imaged in the generated key part 3070 (S1803). The covariant composite key writing section 3064 stores the generated key part 3070 and the key image in the key part 3070 of the covariant composite variable table 307. Since the key image is an image intended to help a user to facilitate grasping the key part 3070 visually, a key image may be generated when the user explicitly indicates to generate it for example.

FIG. 19 is a flowchart for illustrating processing of the contribution variable selection section 308. The contribution variable selection section 308 reads the covariant composite variable table 307 (S1901) and the target variable table (S1902). The contribution variable selection section 308 calculates the contribution degree of each numerical value of the value part 3071 of the covariant composite variable table 307 to the numerical value of the value part of the target variable table 302, (S1903). The contribution variable selection section 308 stores only a column in the respective columns of the covariant composite variable table 307, that has obtained the contribution degree equal to or greater than a threshold value, in the contribution variable table 309 (S1904).

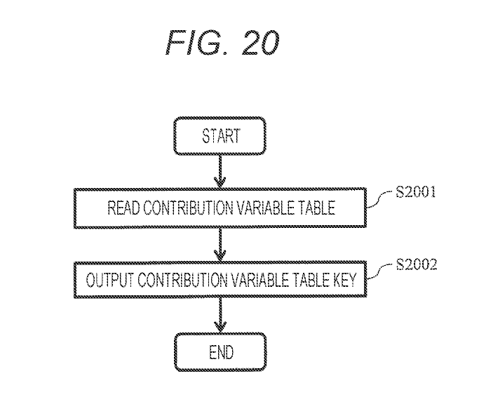

FIG. 20 is a flowchart showing a processing flow of the factor label output section 310. The factor label output section 310 reads the contribution variable table 309 (S2001). The factor label output section 310 outputs all of the contribution variable table keys stored in the key part of the read contribution variable table 309 as the factor label 311 (S2002).

### Embodiment 1

### Summary

The factor extraction system 300 according to the present Embodiment 1 converts the event data table 301 into the event variable table 304, and further converts it into the covariant composite variable table 307. By using the covariant composite variable table 307, it is possible to automatically identify the combination of a plurality of events which effectively contributes to the target variable. That is, since the need for determining the contribution degree by creating a combination of events by hand is eliminated, the contribution factors are efficiently identified, and the factor extraction system 300 may be useful for decision making for improving the target variable.

The factor extraction system 300 according to the present Embodiment 1 can determine the contribution degree to the target variable for each combination of the components of the event data (that is, individual event) by converting the event data table 301 into the event variable table 304. In contrast, in PTLS 1 to 3 for example, even if explanatory variable contributing to the target variable is found, what is found is only a regression relationship of continuous value vs. continuous value between the target variable and the explanatory variable, and thus it is hard for users to understand what kind of the action should be taken in order to actually change the target variable. For example, in the example shown in FIG. 1, although the explanatory variable 104 “number of carrying operations” contributing to the target variable 101 is extracted, how to change the “number of carrying operations” to adjust the target variable 101 cannot be easily understood. In accordance with the factor extraction system 300 according to the present Embodiment 1, as illustrated in FIGS. 9A to 9C, what kind of a combination of events and actions contributes to the target variable can be easily understood.

### Embodiment 2

In Embodiment 1, an example in which the covariant composite variables are constituted by a combination of event variables has been described. Thus, it is possible to support decision making for improving the target variable with combinations of events as a reference. However, when the number of combinations of explanatory variables contributing to the target variable is too large (for example, a combination of several hundreds or thousands of events), the combinations could lead to interfere with the decision making on the contrary. Therefore, in Embodiment 2 of the present invention, a description will be given of a configuration example for reducing the combination of event variables constituting the covariant composite variables effectively. Since other configurations are the same as in Embodiment 1, the covariant composite variable generation section 305 associated with the above description will be mainly described as follows.

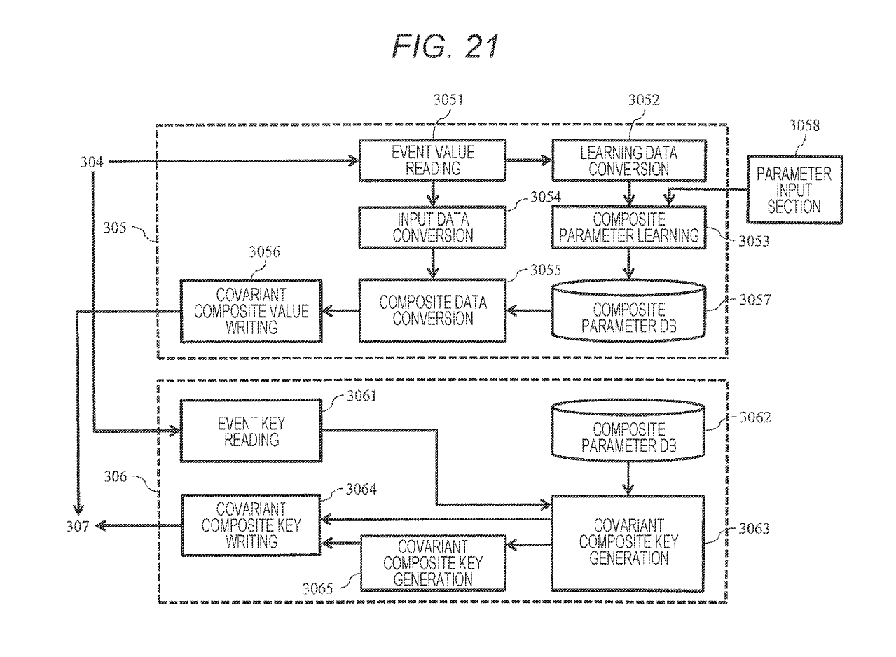

FIG. 21 is a detailed block diagram of the covariant composite variable generation section 305 in the present Embodiment 2. In the present Embodiment 2, the user inputs parameters to be described later via a parameter input section 3058, and the composite parameter learning section 3053 learns the composite parameters using the parameters. Other configurations are similar to those of Embodiment 1. Accordingly other steps in FIG. 17 except the operation in the step S1703 is the same as in Embodiment 1.

The composite parameter learning section 3053 learns composite parameters such that the number of nodes in the event node group 1320 connected to the covariant composite node group 1310 can be reduced effectively. To achieve this, in the reverse calculation rule of the RBM shown in Equation (1), the composite parameters may be learned so that the number of visible layer nodes vᵢ being “1” when “1” is applied to a certain hidden layer node hⱼ is reduced. That is, iterative calculation may be advanced after adjusting the value of Wᵢⱼ or cᵢ which is a parameter so as to reduce the output value of Equation (1). The composite parameter learning section 3053 performs the iterative calculation illustrated in the following Equation (10) in accordance with the above idea, for example, in parallel with Equations (4) to (6) of the RBM learning rules. For each iterative calculation, Equations (4) to (6) are calculated once and Equation (10) is calculated once respectively.

cᵢ=cᵢ−η(P(vᵢ=1|h)−p/N)i=1 to N (10)

The symbol p in the final term in Equation (10) represents a parameter, which the user can specify via the parameter input section 3058. When using Equation (10), for example, the target average value of the number of event nodes connected with the covariant composite node is specified.

P (vᵢ=1|h) is the probability that the visible layer element vᵢ becomes 1 when the hidden layer is h. By using Equation (10), when the value of the hidden layer is given, the RBM is learned to correct so as to reduce the probability that the visible layer is 1. That is, when performing the mutual calculation in the mutual calculation mechanism of the covariant composite network 1301, the composite parameters of the covariant composite network 1301 are calculated so that when a certain composite node becomes “1”, the number of event nodes which become “1” is reduced.

Equation (10) reduces the output value of Equation (1) by reducing the value cᵢ, and thereby reduces the number of nodes in the event node group 1320 connected to the covariant composite node group 1310. As long as the value of Wᵢⱼ or cᵢ can be adjusted so that the number of visible layers having a value of “1” in Equation (1) is reduced, other equations may be used.

### Embodiment 2

### Summary

In accordance with the factor extraction system 300 according to the present Embodiment 2, the covariant composite node can be constituted by a combination of fewer event nodes. Thus, the number of event variables constituting the covariant composite variable is reduced, and the system can output the factor label 311 helping the user easily to make decision.

The present invention is not limited to the form of embodiments described above, and it includes various modifications. The above embodiments are described in detail in order to describe the present invention to be easily understood and are not necessarily limited to those having all the described configurations. A part of the configuration of an embodiment can also be replaced with the configuration of another embodiment. A configuration of another embodiment can also be added in the configuration of an embodiment. Also, for a part of configurations of the embodiments, other configurations can also be added, deleted or replaced.

A part or all of each of the above structures, functions, processing sections and the processing means, etc. may be executed by hardware by designing with an integrated circuit for example. Further, the above configurations and functions, etc. may be achieved by software, with a processor interpreting and executing programs achieving the respective functions. Information such as programs, tables and files achieving each function may be stored in a recording apparatus such as a memory, a hard disk, an SSD (Solid State Drive) and a recording medium such as an IC card, an SD card and a DVD.

### REFERENCE SIGNS LIST

300 factor extraction system
301 event data table
302 target variable table
303 event variable conversion section
304 event variable table
305 covariant composite variable generation section
306 covariant composite variable interpretation section
307 covariant composite variable table
308 contribution variable selection section
309 contribution variable table
310 factor label output section
311 factor label

1. A factor extraction system for extracting a factor contributing to a target variable, the factor extraction system comprising:
an event variable conversion section which converts event data describing a plurality of events constituted by a combination of one or more sets of a first component and a first element value, into event variable data describing an event variable in which a first set of the first component and the first element value is set to be a second component and a value showing by using a binary number whether an event represented by the second component is present in the event data is set to be a second element value;
a covariant composite variable conversion section which converts the event variable data into covariant composite variable data describing a covariant composite variable in which a second set which combines further one or more pieces of the second component constituting the event variable is set to be a third component, and a value showing by using a binary number whether an event represented by the third component is present in the event data is set to be a third element value; and
a contribution variable selection section which obtains a contribution degree of the third component to the target variable by determining a correlation between the target variable and the covariant composite variable, and which outputs the third component whose contribution degree is equal to or greater than a predetermined threshold value.

2. The factor extraction system according to claim 1, wherein
the covariant composite variable conversion section performs machine learning of a correlation between the second component and the third component based on the event data, and converts a set of the second component and the second element value into a set of the third component and the third element value by identifying the third component whose correlation degree with the second component is equal to or greater than a predetermined threshold value.

3. The factor extraction system according to claim 1, wherein
the event variable conversion section extracts all combinations of the first component and the first element value which are present in the event data by acquiring the first component and the first element value regarding all events written in the event data, and generates the event variable by setting all the extracted combinations to be the second component.

4. The factor extraction system according to claim 3, wherein
when the first element value written in the event data is a numerical value, the event variable conversion section, by dividing the first component corresponding to the numerical value into a plurality of numerical value ranges, converts the event data into a combination of the first component and the numerical value ranges, and
further, the event variable conversion section converts the numerical value into a combination of the second component and the second element value by determining which range of the plurality of numerical value ranges includes the numerical value.

5. The factor extraction system according to claim 3, wherein
when the first element value written in the event data is a character string, the event variable conversion section converts the event data into a combination of the first component and the character string by extracting all the character strings that are present in the event data, and
further the event variable conversion section converts the character string into a combination of the second component and the second element value by determining whether the combination of the first component and the character string is included in the event data.

6. The factor extraction system according to claim 1, wherein
when the second component written in the event variable data represents a movement locus of an object to be measured in one of the events, the covariant composite variable conversion section adopts all the movement loci written in the event variable data as the third component.

7. The factor extraction system according to claim 1, further comprising:
a factor label output section which outputs the third component selected by the contribution variable selection section.

8. The factor extraction system according to claim 6, further comprising:
a factor label output section which outputs the third component selected by the contribution variable selection section, wherein
when the third component represents the movement locus, the factor label output section outputs an image obtained by imaging the movement locus, as the third component.

9. The factor extraction system according to claim 1, wherein
the covariant composite variable conversion section converts the event variable data into the covariant composite variable data by repeating machine learning of a first coupling degree between one or more pieces of the second component and the third component in a process of learning from the second component to the third component and machine learning of a second coupling degree between the third component and the second component in a process of reverse learning from the third component to the second component.

10. The factor extraction system according to claim 9, wherein
the covariant composite variable conversion section reduces a number of pieces of the second component coupled to the third component in the process of machine learning of the second coupling degree by subtracting a value of the second coupling degree according to a predetermined rule, as compared with a case where no subtraction is performed.

11. A factor extraction method for extracting a factor contributing to a target variable, the factor extraction method comprising:
converting event data describing a plurality of events constituted by a combination of one or more sets of a first component and a first element value, into event variable data describing an event variable in which a first set of the first component and the first element value is set to be a second component and a value showing by using a binary number whether an event represented by the second component is present in the event data is set to be a second element value;
converting the event variable data into covariant composite variable data describing a covariant composite variable in which a second set which combines further one or more pieces of the second component constituting the event variable is set to be a third component, and a value showing by using a binary number whether an event represented by the third component is present in the event data is set to be a third element value; and
outputting the third component whose contribution degree is equal to or greater than a predetermined threshold value by obtaining the contribution degree of the third component to the target variable by determining a correlation between the target variable and the covariant composite variable.
